(19) United States
(12) Patent Application Publication
(10) Pub. No.: US 2021/0001259 A1
(43) Pub. Date: Jan. 7, 2021

(54) AIR PURIFICATION DEVICE WITH FILTER SCREEN DUST REMOVAL FUNCTION

(71) Applicant: ANHUI CHINTEK INSTRUMENT & EQUIPMENT CO., LTD., Anhui (CN)

(72) Inventors: Jianwu ZHANG, Anhui (CN); Xiaohu ZHANG, Anhui (CN); Yulin YANG, Anhui (CN)

(73) Assignee: ANHUI CHINTEK INSTRUMENT & EQUIPMENT CO., LTD., Anhui (CN)

(21) Appl. No.: 16/307,135

(22) PCT Filed: Oct. 31, 2018
(86) PCT No.: PCT/CN2018/112977

§ 371 Date: Dec. 4, 2018

(30) Foreign Application Priority Data
Sep. 21, 2018 (CN) 201811107269.4

(51) Int. Cl. B01D 46/10; B01D 46/00

(52) U.S. Cl. CPC B01D 46/10; F24F 13/28; B01D 46/0065

(57) ABSTRACT

An air purification device includes a case divided into first and second chambers, a filter unit disposed in the first chamber, and a negative pressure generator disposed in the second chamber. The filter unit comprises an outer frame, a filter screen disposed in the outer frame, and a dust removing device including a dust removing assembly, a first driving mechanism and a second driving mechanism. A peripheral edge of the filter screen is connected to an inner side of the outer frame. The dust removing assembly is movably mounted on the outer frame for removing dust from the filter screen. The first driving mechanism drives the dust removing assembly to move back and forth in a width direction of the filter screen, and the second driving mechanism drives the dust removing assembly to move back and forth in a length direction of the filter screen.

The present application claims priority to Chinese Patent Application No. 201811107269.4, filed to the Chinese Patent Office on Sep. 21, 2018, entitled “AIR PURIFICATION DEVICE WITH FILTER SCREEN DUST REMOVAL FUNCTION”, the entire disclosure of which is incorporated herein by reference.

### TECHNICAL FIELD

The present application relates to air purification technology, and in particular to air purification device with filter screen dust removal function.

### BACKGROUND OF THE APPLICATION

The air purifier with filter has an irreplaceable effect on dust of a certain particle size in the air, and which has a low cost. However, in actual utilization, the dust is easily adsorbed on a surface of the filter screen, gradually blocking meshes, thereby leading to failure. Due to space reasons and non-removability, the cleaning problem of the air filter screen has become a problem that is difficult to handle in the prior art and needs to be solved urgently.

### SUMMARY OF THE INVENTION

Based on the technical problems existing in the background art, the present application provides an air purification device with filter screen dust removal function.

The present application provides an air purification device with filter screen dust removal function, which includes a case, a filter unit, and a negative pressure generator, wherein:

a partition plate is arranged inside the case, the partition plate divides an interior of the case into a first chamber and a second chamber, and the partition plate is configured with a vent communicating with the first chamber and the second chamber; the filter unit is disposed in the first chamber, the case is configured with an air inlet located at an upper position of the filter unit and communicating with the first chamber; the negative pressure generator is disposed in the second chamber, and the case is configured with a plurality of air outlets communicating with the second chamber;

the filter unit comprises an outer frame, a filter screen and a dust removing device, the filter screen is disposed in the outer frame, and a peripheral edge of which is connected to an inner side of the outer frame, the dust removing device comprises a dust removing assembly, a first driving mechanism, and a second driving mechanism, the dust removing assembly is movably mounted on the outer frame, for removing dust from the filter screen, the first driving mechanism is configured to drive the dust removing assembly to move back and forth in a width direction of the filter screen, and the second driving mechanism is configured to drive the dust removing assembly to move back and forth in a length direction of the filter screen.

Preferably, the outer frame includes a first connecting rod, a second connecting rod, a third connecting rod and a fourth connecting rod. The first connecting rod and the second connecting rod are oppositely arranged, and both ends of the first connecting rod and the second connecting rod are respectively connected to the third connecting rod and the fourth connecting rod.

Preferably, the dust removing device further comprises a first guiding rail. The first guiding rail is arranged in the length direction of the filter screen. A first end of the first guiding rail is movably mounted on the first connecting rod, and a second end of the first guiding rail is movably mounted on the second connecting rod. The dust removing assembly is movably mounted on the first guiding rail.

Preferably, a second guide rail is arranged on the first connecting rod in a length direction thereof. The first end of the first guide rail is connected with a first moving block on the second guide rail and is movable with movement of the first moving block along the second guide rail.

Preferably, a third guide rail is arranged on the second connecting rod in a length direction thereof. The second end of the first guide rail is connected with a second moving block on the third guide rail and is movable with movement of the second moving block along the third guide rail.

Preferably, the first driving mechanism includes a first transmission wheel, a second transmission wheel, a third transmission wheel, a fourth transmission wheel, a first conveyor belt, a second conveyor belt, a first motor and a second motor. The first transmission wheel and the second transmission wheel are respectively rotatably mounted at both ends of the first connecting rod in the length direction thereof. The first conveyor belt is installed outside of the first transmission wheel and the second transmission wheel. The first moving block is connected with the first conveyor belt. The first motor is connected with the first transmission wheel and is controlled by a controller to drive the first transmission wheel to rotate. The third transmission wheel and the fourth transmission wheel are respectively rotatably mounted at both ends of the second connecting rod in the length direction thereof, and the second conveyor belt is installed outside of the third transmission wheel and the fourth transmission wheel. The second moving block is connected to the second conveyor, and the second motor is connected to the third transmission wheel and is controlled by the controller to drive the third transmission wheel to rotate.

Preferably, the dust removing assembly comprises a third moving block, a brush body and a dust catching box. The third moving block is slidingly connected with the first guide rail. The dust catching box is mounted on a side of the third moving block, and the brush body is installed at a bottom portion of the third moving block. A plurality of bristles contacting the filter screen are arranged on a bottom portion of the brush body. A plurality of dust suction ports communicating with the dust catching box are arranged at the bottom portion of the brush body.

Preferably, the second driving mechanism includes a fifth transmission wheel, a sixth transmission wheel, a third conveyor belt and a third motor. The fifth transmission wheel and the sixth transmission wheel are respectively rotatably mounted on both ends of the first guide rail. The third transmission belt is installed outside of the fifth transmission wheel and the sixth transmission wheel. The third moving block is connected to the third conveyor, and the third motor is connected to the fifth transmission wheel for driving the fifth transmission wheel to rotate.

The present application provides an air purification device with filter screen dust removal function. The negative pressure generator is turned on, and takes air enter the first chamber from the air inlet. The air filtered and purified by the filter screen of the filter assembly in the first chamber enters the second chamber from the vent, and is discharged from the air outlets. When the air purification device is used for a certain period of time, it is necessary to clean the filter screen. The negative pressure generator is turned off, the first motor, the second motor, the third motor and the dust catching box start. The third motor drives the fifth drive wheel to rotate, and the fifth drive wheel and the sixth drive wheel drives the third conveyor belt to move, then the third drive belt drives the third moving block to move in a length direction of the first guide rail. The third moving block drives the brush body to clean the filter screen and remove the dust, which is sucked into the dust catching box from the dust suction ports. The first motor drives the first transmission wheel to rotate, the second motor drives the three transmission wheels to rotate, the first transmission wheel and the second transmission wheel drive the first conveyor to move, and the first conveyor belt drives the first moving block to move in the length direction of the first connecting rod. The third transmission wheel and the fourth transmission wheel drive the second conveyor belt to move, and the second conveyor belt drives the second moving block to move in the length direction of the second connecting rod. The first moving block and the second moving block drive the first guide rail to move in the length direction of the first connecting rod, thereby realizing the back and forth movement of the dust removing assembly in the length direction of the first connecting rod, and completing the cleaning and dust removing of whole of the filter screen. The present application realizes the movement of the dust removing assembly in two directions by mutual cooperation of the first driving mechanism and the second driving mechanism, which can clean and dust whole of the filter screen to prevent dust accumulation of the filter screen from affecting filtering effect of the filter screen.

### BRIEF DESCRIPTION OF THE DRAWINGS

FIG. 1 is a schematic view of an air purification device with filter screen dust removal function.

FIG. 2 is a schematic view of a filter unit of the air purification device with filter screen dust removal function.

### DETAILED DESCRIPTION OF THE PREFERRED EMBODIMENT

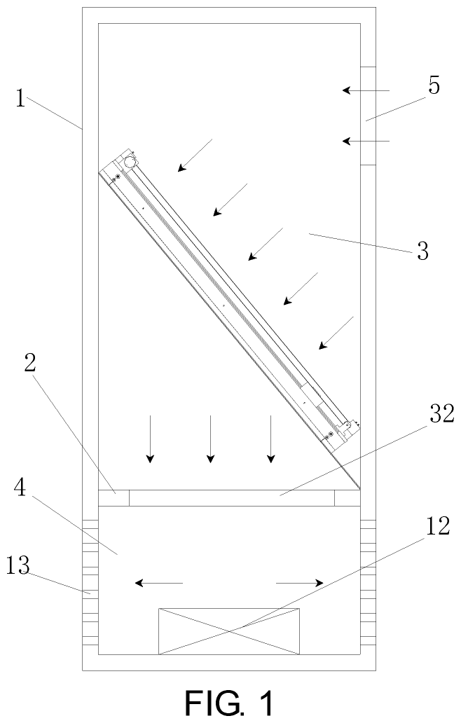

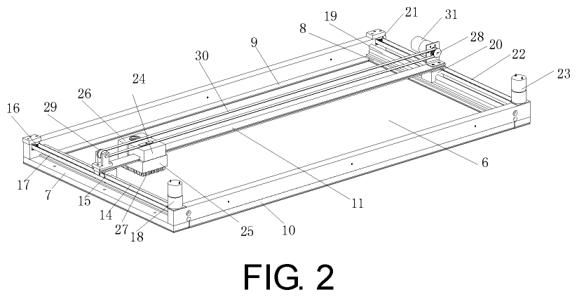

Referring to FIG. 1 and FIG. 2, the present application provides an air purification device with filter screen dust removal function, which includes a case 1, a filter unit and a negative pressure generator 12.

A partition plate 2 is arranged inside of the case 1. The partition plate 2 divides an interior of the case 1 into a first chamber 3 and a second chamber 4, and the partition plate 2 is configured with a vent 32 communicating with the first chamber 3 and the second chamber 4.

The filter unit is disposed in the first chamber 3. The case 1 is configured with an air inlet located at an upper position of the filter unit communicating with the first chamber 3. The negative pressure generator 12 is disposed in the second chamber 4, and the case 1 is configured with a plurality of air outlets 13 communicating with the second chamber 4.

The filter unit comprises an outer frame, a filter screen 6, and a dust removing device. The filter screen 6 is disposed in the outer frame, and a peripheral edge of which is connected to an inner side of the outer frame. The outer frame includes a first connecting rod 7, a second connecting rod 8, a third connecting rod 9, and a fourth connecting rod 10. The first link and the second link are oppositely arranged, and both ends of the first connecting rod 7 and the second connecting rod 8 are respectively connected to the third connecting rod 9 and the fourth connecting rod 10. A second guide rail 14 is arranged on the first connecting rod along its length direction. A third guide rail 19 is arranged on the second connecting rod along its length direction.

The dust removing device comprises a first guiding rail 11, a dust removing assembly, a first driving mechanism, and a second driving mechanism. The first guiding rail 11 is parallel with the third connecting rod 9 and the fourth connecting rod 10. A first end of the first guide rail 11 is connected with the first moving block 15 on the second guide rail 14 and is movable with the first moving block 15 along the second guide rail 14. A second end of the first guide rail 11 is connected with the second moving block 20 on the third guide rail 19 and is movable with the second moving block 20 along the third guide rail 19. The dust removing assembly is movably mounted on the first guiding rail 11 for removing dust from the filter screen 6. The first driving mechanism is configured to drive the dust removing assembly to move back and forth in a width direction of the filter screen 6, and the second driving mechanism is configured to drive the dust removing assembly to move back and forth in a length direction of the filter screen 6.

The dust removing assembly comprises a third moving block 24, a brush body 25, and a dust catching box 26. The third moving block 24 is slidingly connected with the first guide rail 11. The dust catching box 26 is mounted on a side of the third moving block 24. The brush body 25 is installed at a bottom portion of the third moving block 24. A plurality of bristles 27 contacting the filter screen 6 are arranged on a bottom portion of the brush body 25. A plurality of dust suction ports communicating with the dust catching box 26 are arranged at the bottom portion of the brush body 25.

In the embodiment, the first driving mechanism includes a first transmission wheel, a second transmission wheel 16, a third transmission wheel, a fourth transmission wheel 21, a first conveyor belt 17, a second conveyor belt 22, a first motor 18, and a second motor 23. The first transmission wheel and the second transmission wheel 16 are respectively rotatably mounted at both ends of the first connecting rod 7 in the length direction of the first connecting rod 7. The first conveyor belt 17 is installed outside of the first transmission wheel and the second transmission wheel 16. The first moving block 15 is connected with the first conveyor belt 17. The first motor 18 is connected with the first transmission wheel to drive the first transmission wheel to rotate. The third transmission wheel and the fourth transmission wheel 21 are respectively rotatably mounted at both ends on the length direction of the second connecting rod 8. The second conveyor belt 22 is installed outside of the third transmission wheel and the fourth transmission wheel 21. The second moving block 20 is connected to the second conveyor 22, and the second motor 23 is connected to the third transmission wheel to drive the third transmission wheel to rotate.

In the embodiment, the second driving mechanism includes a fifth transmission wheel 28, a sixth transmission wheel 29, a third conveyor belt 30, and a third motor 31. The fifth transmission wheel 28 and the sixth transmission wheel 29 are respectively rotatably mounted on both ends of the first guide rail 11. The third transmission belt 30 is installed outside of the fifth transmission wheel 28 and the sixth transmission wheel 29. The third moving block 24 is connected to the third conveyor 30. The third motor 31 is connected to the fifth transmission wheel 28 for driving the fifth transmission wheel 28 to rotate.

In the embodiment, the negative pressure generator 12 is turned on, and air enters the first chamber 3 from the air inlet 5. The air filtered and purified by the filter screen of the filter assembly in the first chamber 3 enters the second chamber 4 from the vent 32, and is discharged from the air outlets 13 into the room.

When the air purification device is used for a certain period of time, it is necessary to clean the filter screen 6. The negative pressure generator 12 is turned off, and the first motor 18, the second motor 23, the third motor 31 and the dust catching box 26 start. The third motor 31 drives the fifth drive wheel 28 to rotate, the fifth drive wheel 28 and the sixth drive wheel 29 drives the third conveyor belt 30 to move, and the third drive belt 30 drives the third moving block 24 to move in a length direction of the first guide rail 11. The third moving block 24 drives the brush body 25 to clean the filter screen 6 and remove the dust, which is sucked into the dust catching box from dust suction ports. The first motor 28 drives the first transmission wheel to rotate, the second motor 23 drives the third transmission wheels to rotate, the first transmission wheel and the second transmission wheel 16 drive the first conveyor belt 17 to move, and the first conveyor belt 17 drives the first moving block 15 in the length direction of the first connecting rod 7. The third drive wheel and the fourth drive wheel 21 drive the second conveyor 22 to move, and the second conveyor 22 drives the second moving block 20 to move in the length direction of the second connecting rod 8. The first moving block 15 and the second moving block 20 drive the first guide rail 11 to move in the length direction of the first connecting rod 7, thereby realizing the back and forth movement of the dust removing assembly in the length direction of the first connecting rod 7, and completing the cleaning and dust removing work of the whole filter screen 6.

The present application realizes the movement of the dust removing assembly in two directions by mutual cooperation of the first driving mechanism and the second driving mechanism, which can clean and dust whole of the filter screen 6 to prevent the filter dust accumulation from affecting the filtering effect of the filter screen 6.

The above is only the preferred embodiment of the present application, but the scope of protection of the present application is not limited thereto, and any equivalents or modifications of the technical solutions of the present application and the application concept thereof should be included in the scope of the present application within the scope of the technical scope of the present application.

1. An air purification device with filter screen dust removal function, comprising a case, a filter unit and a negative pressure generator, wherein:
a partition plate is arranged inside the case, the partition plate divides an interior of the case into a first chamber and a second chamber, and the partition plate is configured with a vent communicating with the first chamber and the second chamber;
the filter unit is disposed in the first chamber, the case is configured with an air inlet located at an upper position of the filter unit and communicating with the first chamber; the negative pressure generator is disposed in the second chamber, and the case is configured with a plurality of air outlets communicating with the second chamber; and
the filter unit comprises an outer frame, a filter screen and a dust removing device, the filter screen is disposed in the outer frame, and a peripheral edge of the filter screen is connected to an inner side of the outer frame, the dust removing device comprises a dust removing assembly, a first driving mechanism, and a second driving mechanism, the dust removing assembly is movably mounted on the outer frame for removing dust from the filter screen, the first driving mechanism is configured to drive the dust removing assembly to move back and forth in a width direction of the filter screen, and the second driving mechanism is configured to drive the dust removing assembly to move back and forth in a length direction of the filter screen.

2. The air purification device with filter screen dust removal function according to claim 1, wherein the outer frame includes a first connecting rod, a second connecting rod, a third connecting rod, and a fourth connecting rod, the first connecting rod and the second connecting rod are oppositely arranged, and both ends of the first connecting rod and the second connecting rod are respectively connected to the third connecting rod and the fourth connecting rod.

3. The air purification device with filter screen dust removal function according to claim 2, wherein the dust removing device further comprises a first guiding rail, the first guiding rail is arranged in the length direction of the filter screen, a first end of the first guiding rail is movably mounted on the first connecting rod, a second end of the first guiding rail is movably mounted on the second connecting rod, and the dust removing assembly is movably mounted on the first guiding rail.

4. The air purification device with filter screen dust removal function according to claim 3, wherein a second guide rail is arranged on the first connecting rod arranged in a length direction thereof, the first end of the first guide rail is connected with a first moving block on the second guide rail and is movable with movement of the first moving block along the second guide rail.

5. The air purification device with filter screen dust removal function according to claim 4, wherein a third guide rail is arranged on the second connecting rod in a length direction thereof, and the second end of the first guide rail is connected with a second moving block on the third guide rail and is movable with movement of the second moving block along the third guide rail.

6. The air purification device with filter screen dust removal function according to claim 5, wherein the first driving mechanism includes a first transmission wheel, a second transmission wheel, a third transmission wheel, a fourth transmission wheel, a first conveyor belt, a second conveyor belt, a first motor and a second motor, the first transmission wheel and the second transmission wheel are respectively rotatably mounted at both ends of the first connecting rod in the length direction thereof, the first conveyor belt is installed outside of the first transmission wheel and the second transmission wheel, the first moving block is connected with the first conveyor belt, the first motor is connected with the first transmission wheel and is controlled by a controller to drive the first transmission wheel to rotate; the third transmission wheel and the fourth transmission wheel are respectively rotatably mounted at both ends of the second connecting rod on the length direction thereof, the second conveyor belt is installed outside of the third transmission wheel and the fourth transmission wheel, the second moving block is connected to the second conveyor, and the second motor is connected to the third transmission wheel and is controlled by the controller to drive the third transmission wheel to rotate.

7. The air purification device with filter screen dust removal function according to claim 3, wherein the dust removing assembly comprises a third moving block, a brush body and a dust catching box, the third moving block is slidingly connected with the first guide rail, the dust catching box is mounted on a side of the third moving block, the brush body is installed at a bottom portion of the third moving block, a plurality of bristles contacting the filter screen are arranged on a bottom portion of the brush body, and a plurality of dust suction ports communicating with the dust catching box are arranged at the bottom portion of the brush body.

8. The air purification device with filter screen dust removal function according to claim 7, wherein a third driving mechanism includes a fifth transmission wheel, a sixth transmission wheel, a third conveyor belt, and a third motor, the fifth transmission wheel and the sixth transmission wheel are respectively rotatably mounted on both ends of the first guide rail, the third transmission belt is installed outside of the fifth transmission wheel and the sixth transmission wheel, the third moving block is connected to the third conveyor, and the third motor is connected to the fifth transmission wheel for driving the fifth transmission wheel to rotate.
